(19) United States
(12) Patent Application Publication
(10) Pub. No.: US 2024/0005102 A1
(43) Pub. Date: Jan. 4, 2024

(54) CONTEXTUALIZED CONTENT DELIVERY FOR MORTGAGES

(71) Applicant: Truist Bank, Charlotte, NC (US)

(72) Inventors: Kaitlin Honeyager, Waukesha, WI (US); Stephen Gary Hess, Palm Springs, CA (US)

(21) Appl. No.: 17/855,985

(22) Filed: Jul. 1, 2022

(51) Int. Cl. G06F 40/40; G06F 40/284; G06F 40/295

(52) U.S. Cl. CPC G06F 40/40; G06F 40/284; G06F 40/295

(57) ABSTRACT

In some implementations, the techniques include receiving a query from a user via a user device. The query may include one or more mortgage questions. In addition, the techniques may include accessing an account history may include financial information associated with the user and/or a query history for the user. Also, the techniques may include accessing market data. Further, the techniques may include providing the query, the account history, and/or the market data as an input to a virtual assistant application. The virtual assistant application may generates a response to the query using a knowledge base may include mortgage information. In addition, the techniques may include receiving the response as an output from the virtual assistant application.

### TECHNICAL FIELD

The present disclosure relates generally to content delivery operations and, more particularly (although not necessarily exclusively), to contextualized content delivery.

### BACKGROUND

Answering questions about mortgages can be confusing and overwhelming for consumers. A consumer may have to gather large amounts of personal data before they can receive a clear answer to mortgage related questions. Consumers may delay beginning the home buying process because of the difficulty in finding relevant mortgage information. Accordingly, improvements in content delivery for mortgages is desirable.

### SUMMARY

In one general aspect, techniques may include receiving a query from a user via a user device. The query may include one or more mortgage questions. In addition, the techniques may include accessing an account history that can include financial information associated with the user and/or a query history for the user. The techniques may also include accessing market data. The techniques may further include providing the query, the account history, and/or the market data as an input to a virtual assistant application that generates a response to the query. The response can be generated using a knowledge base including mortgage information. The techniques may in addition include receiving the response as an output from the virtual assistant application. Other embodiments of this aspect include corresponding computer systems, apparatus, and computer programs recorded on one or more computer storage devices, each configured to perform the actions of the methods.

Implementations may include one or more of the following features. Techniques where providing the query further may include processing the query using one or more natural language processing (NLP) techniques. Techniques where the one or more natural language processing (NLP) techniques may include tokenization, sentiment analysis, normalization, named entity recognition, and/or dependency parsing. Techniques where the virtual assistant application may include a machine learning model. Techniques where the machine learning model is a neural network. Techniques where the market data may include a mortgage interest rate. Techniques where the query history may include a record of questions and responses between the user and the virtual assistant application. Techniques where the financial information associated with the user may include one or more bank account statements, a credit history, one or more proof of income documents, and/or one or more tax returns. Implementations of the described techniques may include hardware, a method or process, or a computer readable medium.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

Reference to the remaining portions of the specification, including the drawings and claims, will realize other features and advantages of the present disclosure. Further features and advantages of the present disclosure, as well as the structure and operation of various embodiments of the present disclosure, are described in detail below with respect to the accompanying drawings. In the drawings, like reference numbers can indicate identical or functionally similar elements.

### BRIEF DESCRIPTION OF THE DRAWINGS

FIG. 1 depicts a machine learning model according to the embodiments of the present invention.

FIG. 2 shows an example machine learning model of a neural network according to an embodiment.

FIG. 3 shows a method for providing contextualized content delivery for a mortgage according to an embodiment.

FIG. 4 is a simplified block diagram illustrating an example architecture of a system for a virtual assistant, according to some embodiments.

FIG. 5 shows a simplified diagram of a computer system according to an embodiment.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Embodiments of the present disclosure can provide techniques for a virtual assistant that can provide contextualized mortgage content in response to queries. The virtual assistant can be part of a computer system that a user can interact with through a user device such as a mobile phone. A user can provide a query to the virtual assistant and the assistant can use a machine learning model, or a set of predefined rules, to generate a response to the query.

A mortgage loan, or mortgage, is a loan that is secured by a piece of real property. A mortgage may be used to finance a home purchase, and the home, or real property, can be used as collateral for the loan. At purchase, the consumer pays a percentage of the real property's purchase price to the seller. This percentage payment is called a down payment, and the lender pays the seller the balance of the purchase price left after the down payment. In the event the purchaser defaults on the loan, the lender can take possession, or foreclose, the real property used to secure the loan. A mortgage can mitigate the lender's risk in offering the loan because the lender can sell the real property to cover any expenses caused by a purchaser's default.

A mortgage is a complex financial transaction and for many consumers it can be both confusing and intimidating. Consumers may find it difficult to turn to friends and family for information because intimate financial details may need to be disclosed in order to accurately discuss mortgages. For example, a consumer may not feel comfortable disclosing his or her income and credit score to a friend or family member. In addition, mortgages infrequent transactions for the average consumer and a parent's advice to their child may be decades out of date.

Commercial resources, such as websites, books, television programs, or recorded videos may be imperfect sources of loan information. Such resources may present information in a dense format that is difficult for the average consumer to understand. It may be challenging for a consumer to receive a straightforward answer in a simple format, and a consumer may spend time searching through irrelevant information before finding an appropriate answer. In addition, these resources can provide general information that does not take a consumer's individual characteristics into account. For instance, some banks have special mortgage programs for medical doctors and a doctor reading a general article on mortgagees may learn about these programs.

A bank's loan officers can be a helpful resource for learning about mortgages. However, consumers may approach a loan officer late in their home buying process. For example, a consumer may not approach a loan officer until they have spent several years saving for a mortgage down payment. If the consumer had received information earlier in the loan process they may have been able to better prepare for a loan. For instance, a consumer, after saving several years for a down payment, may approach a loan officer to find that the consumer needs to improve their credit score. If the consumer had been presented with this information when they began saving, the consumer may have been able to purchase a home sooner.

A virtual assistant can provide a consumer with contextualized mortgage information in an easily understandable format. A virtual assistant can provide information to a consumer in a query-response format that mimics human conversation. Rather than providing the consumer with dense informational material, the consumer can ask questions that the virtual assistant answers. The answers can be plain language responses and the virtual assistant can point the consumer to relevant educational resources.

A consumer's conversations with the virtual assistant can be used to improve the virtual assistant's responses. For instance, if a consumer replies “what do you mean?” to a response provided by the virtual assistant, the virtual assistant can learn that the response may need to be improved. These questions and responses can be used to train a machine learning model for the virtual assistant or to develop rules that determine the virtual assistant's responses.

The virtual assistant can use personal information for the consumer to provide contextualized answers to a consumer's questions. The virtual assistant can use information about the consumer's financial history, education, or location to determine responses to a consumer's questions. For example, a consumer living in Fresno California may ask “Is it a good time to buy a house?” and the virtual assistant's response can be informed by the local housing market and the consumer's financial information. The virtual assistant could reply, “It is not a good time to buy a house because mortgage interest rates are high and home prices are increasing.” Later when the housing market improves, the virtual assistant can send a notification to the consumer that conditions have changed and it is now a good time to buy a home.

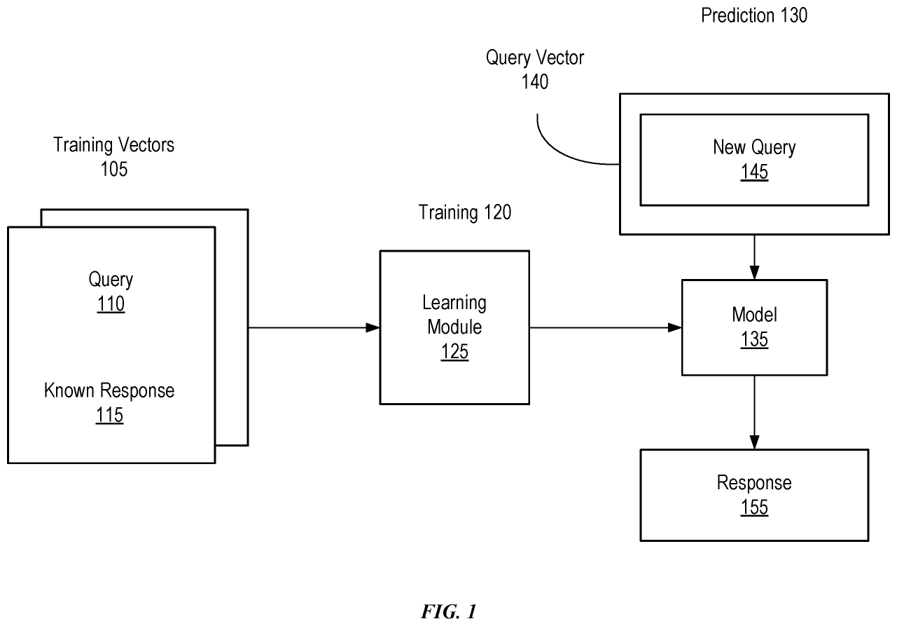

FIG. 1 depicts a machine learning model according to the embodiments of the present invention. Training vectors 105 are shown with query 110 and a known response 115. As examples, a query could be a request for information about a mortgage. For ease of illustration, only two training vectors are shown, but the number of training vectors may be much larger, e.g., 10, 50, 100, 1,000, 10,000, 100,000, or more. Training vectors could be made for one user (e.g. one consumer), one or more users over a fixed time period, queries from one or more users on a particular topic (e.g., questions about interest rates), or queries from users with related characteristics (e.g., first time homebuyers, recent college graduates, users between 30 years old and 40 years old, users with assets below $100,000, etc.).

Training vectors 105 can be used by a learning module 125 to perform training 120. Learning module 125 can optimize parameters of a model 135 such that a quality metric (e.g., accuracy of model 135) is achieved with one or more specified criteria. The accuracy may be measured by comparing known responses 115 to predicted classifications. Parameters of model 135 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 130 can provide a predicted response 155 for a new query's query vector 140 based on new query 145. The new entity records can be of a similar type as entity record 110. If new entity records are of a different type, a transformation can be performed on the data to obtain data in a similar format as entity record 110. Ideally, predicted response 155 corresponds to the question encoded in query vector 140.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

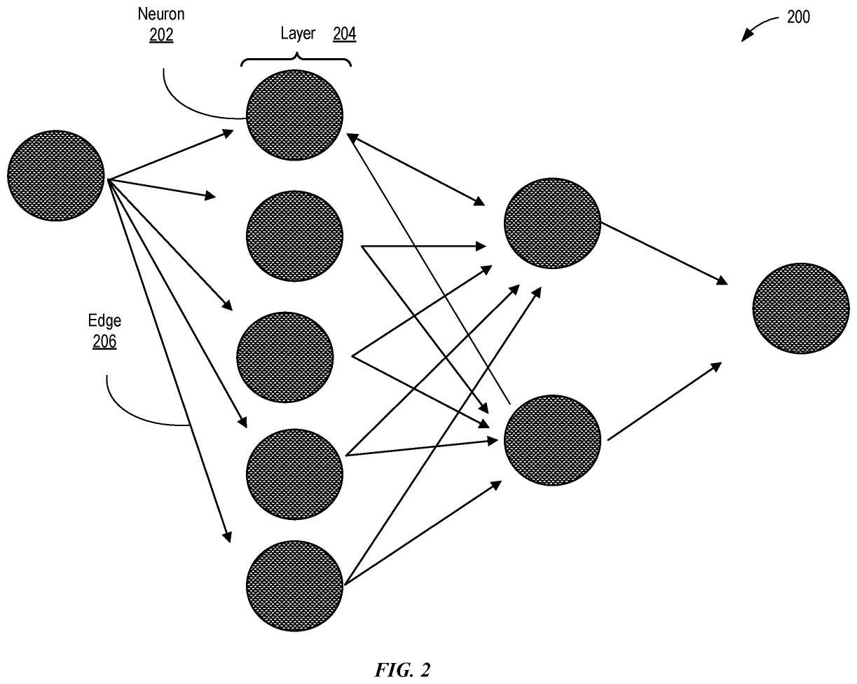

FIG. 2 shows an example machine learning model of a neural network 200 according to an embodiment. As an example, model 135 can be a neural network that comprises a number of neurons 202 (e.g., Adaptive basis functions) organized in layers 204. The neurons 202, or nodes, can be connected by edges 206. The training of the neural network can iteratively search for the best configuration of the parameter of the neural network for feature recognition and classification performance. Various numbers of layers and nodes may be used. A person with skills in the art can easily recognize variations in a neural network design and design of other machine learning models.

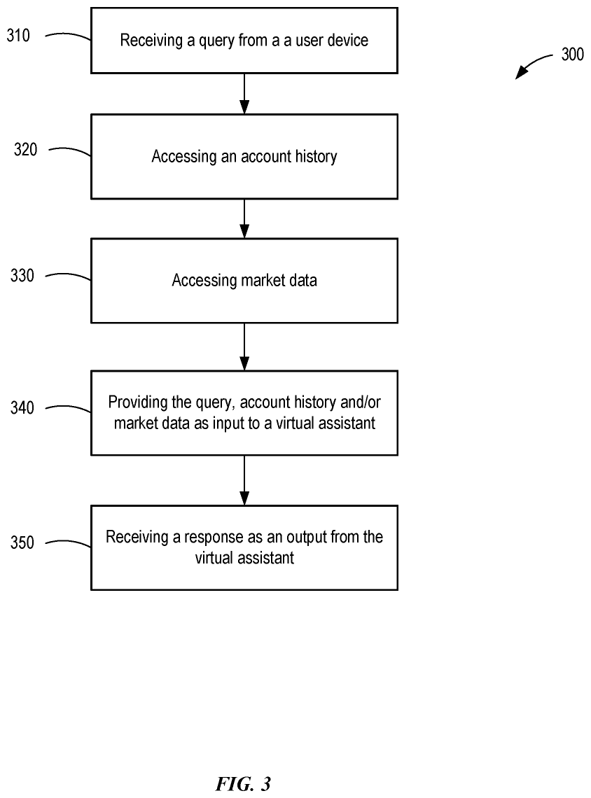

FIG. 3 shows a method 300 for providing contextualized content delivery for a mortgage according to an embodiment. This method is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method.

Turning to method 300 in greater detail, at block 310, a query can be received from a user device. The query (e.g., query 110, new query 145, etc.) can be received at a computing device (e.g., computing device 402, computer system 510) from a user device (e.g., user devices 404). A user (e.g., a consumer) controlling the user device can be an authenticated user, and the query can be provided after the user has been authenticated (e.g., logged into an account via an application programming interface (API)). The query can be provided from a user device to the computing device via a network (e.g., networks 408, etc.).

At block 320, the computing device can access an account history. The account history can include financial information such as account statements from one or more bank accounts associated with one or more financial institutions. The bank accounts can include loans, savings accounts, checking accounts, investment accounts, credit card accounts, student loans accounts, mortgages, etc. The financial information can include a credit history or credit score for the user, an employment history, an educational history, a current address, etc. The account history can include a query history representing queries (e.g., query 110, new query 145, etc.) and responses (known responses 115, response 155, etc.) between the user or user device and the virtual assistant. The query history can be used as training vectors 105 that can be used to train a machine learning model. The machine learning model can be a neural network such as neural network 200. The account information or query history can be retrieved by the computing device from memory (e.g., memory 412, storage 418, system memory 572, storage device 579, etc.) or via a network (e.g., networks 408, etc.) from a computing device (e.g., computing device 402, user devices 404, server device 410, computer system 510, etc.).

At block 330, the computing device can access market data. The market data can include interest rates for one or more countries such as the federal funds rate set by the United States Federal Reserve. The market data can also include individual stock prices or composite stock prices (e.g., Dow Jones Industrial Average). The market data can include individual cryptocurrency prices or composite cryptocurrency prices. The market data can include stock or cryptocurrency price trends or changes in market capitalization for stocks, cryptocurrencies, groups of stocks, groups of cryptocurrencies, etc. The market data can also include housing market information for a market such as the average price of a single family home, the average price per square foot for residential real estate, the average price per square foot for commercial real estate, the vacancy rate for residential real estate, the vacancy rate for commercial real estate, the average time that real estate is on the market before sale, etc. The market can be any geographic division such as a country, state, city, region, metropolitan area, zip code, or other administrative unit.

At block 340, the account history, query, and/or market data can be provided as an input to the virtual assistant application. A response to a query can be generated by the virtual assistant application. The virtual assistant application can be stored in the virtual assistant module 430. The virtual assistant application can use a machine learning model (e.g., model 135, model 438, etc.) to generate a response (e.g., response 155, etc.) to a query (e.g., new query 145, etc.). The query can be transformed into a vector (query vector 140, etc.) or another machine-readable format before the query in input to the machine learning model. The query may be processed using natural language processing (NLP) techniques before the query is input to the machine learning model. The NLP techniques can include tokenization, sentiment analysis, normalization, named entity recognition, and/or dependency parsing. A rules-based module 450 can use rules to generate a response to a query.

At block 350, a response can be received as an output from the virtual assistant. The response produced by the machine learning module or rules-based module can be a natural language response that mimics human conversation. The response can be provided to the user device (e.g., user devices 404).

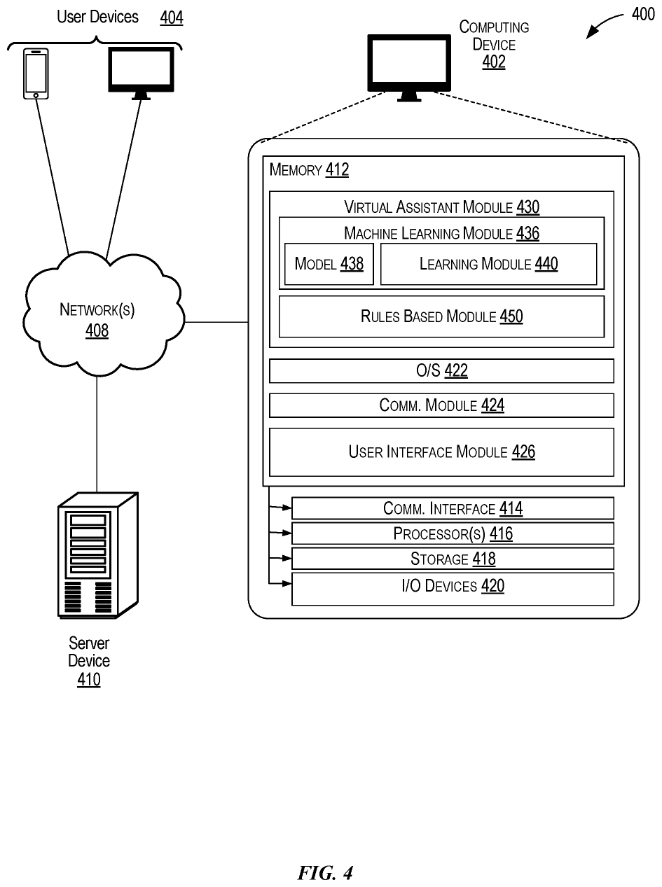

FIG. 4 is a simplified block diagram 400 illustrating an example architecture of a system for a virtual assistant, according to some embodiments. The diagram includes a representative computing device 402, one or more user devices 404, one or more network(s) 408, and a server device 410. Each of these elements depicted in FIG. 4 may be similar to one or more elements depicted in other figures described herein.

The user devices 404 may be any suitable computing device (e.g., smartphone, smartwatch, personal computer, tablet computer, etc.). In some embodiments, a user device may perform any one or more of the operations of user devices described herein. Depending on the type of user device and/or location of the user device, the user device may be enabled to communicate using one or more network protocols (e.g., a Bluetooth connection, a Thread connection, a Zigbee connection, a WiFi connection, etc.) and network paths over the network(s) 408 (e.g., including a LAN or WAN), described further herein.

In some embodiments, the server device 410 may be a computer system that comprises at least one memory, one or more processing units (or processor(s)), a storage unit, a communication device, and an I/O device. In some embodiments, the server device 410 may perform any one or more of the operations of server devices described herein. In some embodiments, these elements may be implemented similarly (or differently) than as described in reference to similar elements of computing device 402.

In some embodiments, the representative computing device 402 may correspond to any one or more of the computing devices described herein. The representative computing device may be any suitable computing device (e.g., a server computer, a personal computer, a tablet computer, a smartphone, etc.).

In some embodiments the one or more network(s) 408 may include an Internet WAN and a LAN. As described herein, the home environment may be associated with the LAN, whereby devices present within the monitored environment may communicate with each other over the LAN. As described herein, the WAN may be external from the monitored environment. For example, a router associated with the LAN (and thus, the monitored environment) may enable traffic from the LAN to be transmitted to the WAN, and vice versa. In some embodiments, the server device 410 may be external to the monitored environment, and thus, communicate with other devices over the WAN.

As described herein, computing device 402 may be representative of one or more computing devices connected to one or more of the network(s) 408. The computing device 402 has at least one memory 412, a communications interface 414, one or more processing units (or processor(s) 416, a storage unit 418, and one or more input/output (I/O) device(s) 420.

Turning to each element of computing device 402 in further detail, the processor(s) 416 may be implemented as appropriate in hardware, computer-executable instructions, firmware or combinations thereof. Computer-executable instruction or firmware implementations of the processor(s) 416 may include computer-executable or machine executable instructions written in any suitable programming language to perform the various functions described.

The memory 412 may store program instructions that are loadable and executable on the processor(s) 416, as well as data generated during the execution of these programs. Depending on the configuration and type of computing device 402, the memory 412 may be volatile (such as random access memory (“RAM”)) or non-volatile (such as read-only memory (“ROM”), flash memory, etc.). In some implementations, the memory 412 may include multiple different types of memory, such as static random access memory (“SRAM”), dynamic random access memory (“DRAM”) or ROM. The computing device 402 may also include additional storage 418, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some embodiments, the storage 418 may be utilized to store data contents received from one or more other devices (e.g., server device 410, other computing devices, or user devices 404).

The computing device 402 may also contain the communications interface 414 that allows the computing device 402 to communicate with a stored database, another computing device or server, user terminals, or other devices on the network(s) 408. The computing device 402 may also include I/O device(s) 420, such as for enabling connection with a keyboard, a mouse, a pen, a voice input device, a touch input device, a display, speakers, a printer, etc. In some embodiments, the I/O devices(s) 420 may be used to output an audio response or other indication as part of executing the response to a user request. The I/O device(s) can include one or more speakers 446 or one or more microphones 448.

The memory 412 may include an operating system 422 and one or more application programs or services for implementing the features disclosed herein, including a communications module 424, a user interface module 426, a virtual assistant module 430, accessory interaction instance(s) 432, and a management module 434. The virtual assistant module further comprises a machine learning module 436. The sound processing module further comprises a rules based module 450 that can be configured to determine a response to a query using predefined rules.

The communications module 424 may comprise code that causes the processor(s) 416 to generate instructions and messages, transmit data, or otherwise communicate with other entities. As described herein, the communications module 424 may transmit messages via one or more network paths of network(s) 408 (e.g., via a LAN associated with the monitored environment or an Internet WAN). The user interface module 426 may comprise code that causes the processor(s) 416 to present information corresponding to the computing devices and user devices present within or associated with a monitored environment.

The virtual assistant module 430 can comprise code that causes the processor(s) 416 to receive and process queries by techniques described herein machine learning module 436 can comprise code that causes processor(s) 416 to receive and process a portion of an audio or textual input corresponding to a query. For example, machine learning module 436 can analyze a portion of an audio or textual input to determine a response to a query. The speech processing module can also, in some embodiments, determine a language corresponding to the audio or textual input and use that language to inform the analysis of the query and response. Learning module 440 can be used to train a model to determine a response to a query as described herein. Rules based module 450 can comprise code that causes processor(s) 416 to receive and process a portion of an audio or textual input corresponding to a query using predefined rules.

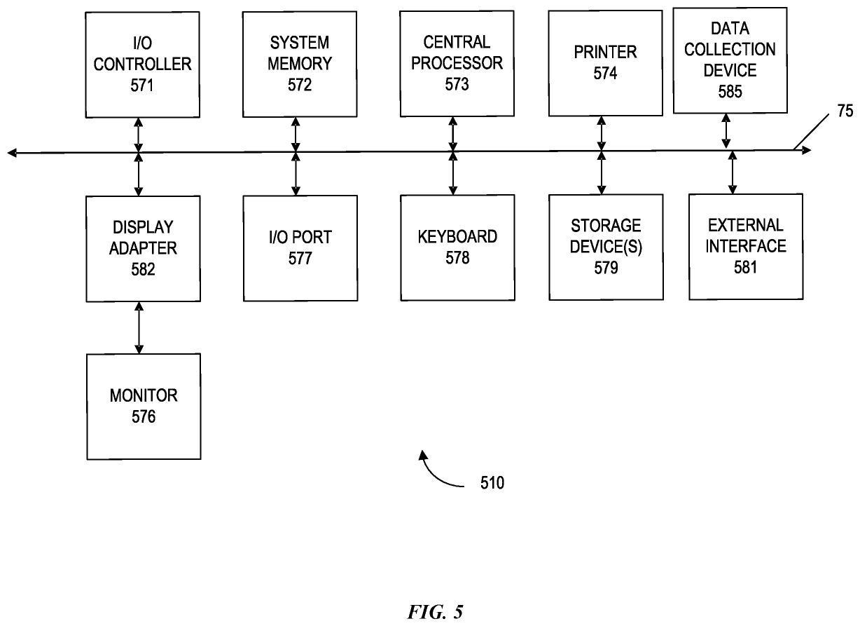

FIG. 5 shows a simplified diagram of a computer system according to an embodiment. Any of the computer systems mentioned herein may utilize any suitable number of subsystems. Examples of such subsystems are shown in FIG. 5 in computer system 510. In some embodiments, a computer system includes a single computing device, where the subsystems can be the components of the computing device. In other embodiments, a computer system can include multiple computing devices, each being a subsystem, with internal components. A computer system can include desktop and laptop computers, tablets, mobile phones and other mobile devices.

The subsystems shown in FIG. 5 are interconnected via a system bus 575. Additional subsystems such as a printer 574, keyboard 578, storage device(s) 579, monitor 576 (e.g., a display screen, such as an LED), which is coupled to display adapter 582, and others are shown. Peripherals and input/output (I/O) devices, which couple to I/O controller 571, can be connected to the computer system by any number of means known in the art such as input/output (I/O) port 577 (e.g., USB, FireWire®). For example, I/O port 577 or external interface 581 (e.g. Ethernet, Wi-Fi, etc.) can be used to connect computer system 510 to a wide area network such as the Internet, a mouse input device, or a scanner. The interconnection via system bus 575 allows the central processor 573 to communicate with each subsystem and to control the execution of a plurality of instructions from system memory 572 or the storage device(s) 579 (e.g., a fixed disk, such as a hard drive, or optical disk), as well as the exchange of information between subsystems. The system memory 572 and/or the storage device(s) 579 may embody a computer readable medium. Another subsystem is a data collection device 585, such as a camera, microphone, accelerometer, and the like. Any of the data mentioned herein can be output from one component to another component and can be output to the user.

A computer system can include a plurality of the same components or subsystems, e.g., connected together by external interface 581, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A computer-implemented method, comprising:
receiving, by a computing device, a query from a user device, the query comprising one or more mortgage questions;
accessing, by the computing device, an account history comprising financial information associated with a user and/or a query history for the user;
accessing, by the computing device, market data;
providing, by the computing device, the query, the account history, the market data, or a combination thereof as an input to a virtual assistant application that generates a response to the query; and
receiving, by the computing device, the response as an output from the virtual assistant application.

2. The method of claim 1, wherein providing the query further comprises:
processing, by the computing device, the query using one or more natural language processing (NLP) techniques.

3. The method of claim 2, wherein the one or more natural language processing (NLP) techniques comprise tokenization, sentiment analysis, normalization, named entity recognition, and/or dependency parsing.

4. The method of claim 1, wherein the virtual assistant application comprises a machine learning model.

5. The method of claim 4, wherein the machine learning model is a neural network.

6. The method of claim 1, wherein the market data comprises a mortgage interest rate.

7. The method of claim 1, wherein the query history comprises a record of questions and responses between the user and the virtual assistant application.

8. The method of claim 1, wherein the financial information associated with the user comprises one or more bank account statements, a credit history, one or more proof of income documents, and/or one or more tax returns.

9. A system comprising:
one or more processors configured to:
receive, by a computing device, a query from a user device, the query comprising one or more mortgage questions;
access, by the computing device, an account history comprising financial information associated with a user and/or a query history for the user;
access, by the computing device, market data;
provide, by the computing device, the query, the account history, and/or the market data as an input to a virtual assistant application that generates a response to the query using a knowledge base comprising mortgage information; and
receive, by the computing device, the response as an output from the virtual assistant application.

10. The system of claim 9, wherein providing the query further comprises:
processing, by the computing device, the query using one or more natural language processing (NLP) techniques.

11. The system of claim 10, wherein the one or more natural language processing (NLP) techniques comprise tokenization, sentiment analysis, normalization, named entity recognition, and/or dependency parsing.

12. The system of claim 9, wherein the virtual assistant application comprises a machine learning model.

13. The system of claim 12, wherein the machine learning model is a neural network.

14. The system of claim 9, wherein the financial information associated with the user comprises one or more bank account statements, a credit history, one or more proof of income documents, and/or one or more tax returns.

15. A non-transitory computer-readable medium storing a set of instructions, the set of instructions comprising:
one or more instructions that, when executed by one or more processors of a computing device, cause the device to:
receive a query from a user device, the query comprising one or more mortgage questions;
access an account history comprising financial information associated with a user and/or a query history for the user;
access market data;
provide the account history, and/or the market data as an input to a virtual assistant application that generates a response to the query using a knowledge base comprising mortgage information; and
receive the response as an output from the virtual assistant application.

16. The non-transitory computer-readable medium of claim 15, wherein providing the query further comprises:
processing, by the computing device, the query using one or more natural language processing (NLP) techniques.

17. The non-transitory computer-readable medium of claim 16, wherein the one or more natural language processing (NLP) techniques comprise tokenization, sentiment analysis, normalization, named entity recognition, and/or dependency parsing.

18. The non-transitory computer-readable medium of claim 15, wherein the virtual assistant application comprises a machine learning model.

19. The non-transitory computer-readable medium of claim 18, wherein the machine learning model is a neural network.

20. The non-transitory computer-readable medium of claim 15, wherein the market data comprises a mortgage interest rate.
